(19) United States
(12) Patent Application Publication
(10) Pub. No.: US 2007/0289539 A1
(43) Pub. Date: Dec. 20, 2007

(54) Apparatus for feeding swine and piglets

(76) Inventors: Keith Berry, Putnam County, IN (US); Brian Berry, Putnam County, IN (US)

Correspondence Address: Jack Schuman, 3762 Carmel Drive, Carmel, IN, 46033-4329, US

(21) Appl. No.: 11/430,099

(22) Filed: May 9, 2006

(51) Int. Cl. A01K 7/06; A01K 5/00

(52) U.S. Cl. 119/54; 119/72

(57) ABSTRACT

Feed dispenser has opening at bottom surrounded by a seat upon which a ball check is adapted to rest, thereby to seal the opening and prevent the discharge of feed. Feed lever secured to ball check can be nudged upwardly by swine to elevate ball check to unseal opening, and can be nudged laterally by piglet to rotate ball check on the seat so that a crevice in the ball check can be brought below opening to drop feed into feed pit.

### BACKGROUND OF THE INVENTION

1. Field of the Invention

This invention pertains to a novel and efficient improved apparatus for feeding animals such as swine and piglets.

2. Description of the Prior Art

Conventionally, in the raising of swine, e.g. sows, each sow has access to an individual pit served by a hopper or dispenser into which feed is introduced, such feed dropping out of the restricted bottom of the hopper or dispenser into the pit, whether or not such feed is required by the sow. Such conventional practice encouraged spoilage of the feed and could be very wasteful.

A significant improvement in the feeding of animals such as swine, e.g. sows, is disclosed in U.S. Pat. No. 6,101,975 granted to the same inventors as are identified herein. The invention disclosed in U.S. Pat. No. 6,101,975 comprises an adjustable ball check in the bottom of the hopper or dispenser, which ball check ordinarily closes the bottom thereof, thereby preventing the discharge of feed therefrom into the pit, which ball check can be nudged upwardly by the sow, which is easily trained to perform this function, thereby to release feed into the pit.

However, it has been discovered that piglets, perhaps only a few weeks old, do not have the strength to nudge the ball check upwardly so as to release feed from the hopper or dispenser.

### SUMMARY OF THE INVENTION

One of the objects of this invention is to provide an improved and efficient apparatus for feeding piglets as well as more mature sows.

Other and further objects of this invention will become apparent by reference to the accompanying specification and drawings, and to the appended claims.

Briefly, we have discovered that the foregoing objects may be attained by providing crevices in the ball check holding feed, which crevices can drop feed into the pit when the ball check is rotated by piglets pushing against a downwardly extending feed lever secured to the bottom of the ball check, in addition to the ball check being lifted upwardly by more mature sows.

### DESCRIPTION OF THE DRAWINGS

Referring now to the drawings, in which like numerals represent like parts in the several views:

FIG. 1 represents diagrammatically and not to scale a cross-section in elevation of the pit, showing the feed dispenser, the ball check partially in section to show a crevice therein, the feed trough in the bottom of the pit, and a water reservoir in the bottom of the pit.

FIG. 2 represents a cross-section in elevation and not to scale, showing the bottom portion of the feed dispenser engaging the ball check, crevices in the ball check, and the feed lever.

FIG. 3 represents a view similar to that shown in FIG. 2, showing the feed lever being raised as indicated by the arrow to elevate the ball check, thereby releasing feed from the dispenser into the pit.

FIG. 4 represents a view similar to that shown in FIG. 2, the feed lever being moved laterally, as by a piglet, thereby rotating the ball check and enabling a crevice in the ball check to release feed into the pit.

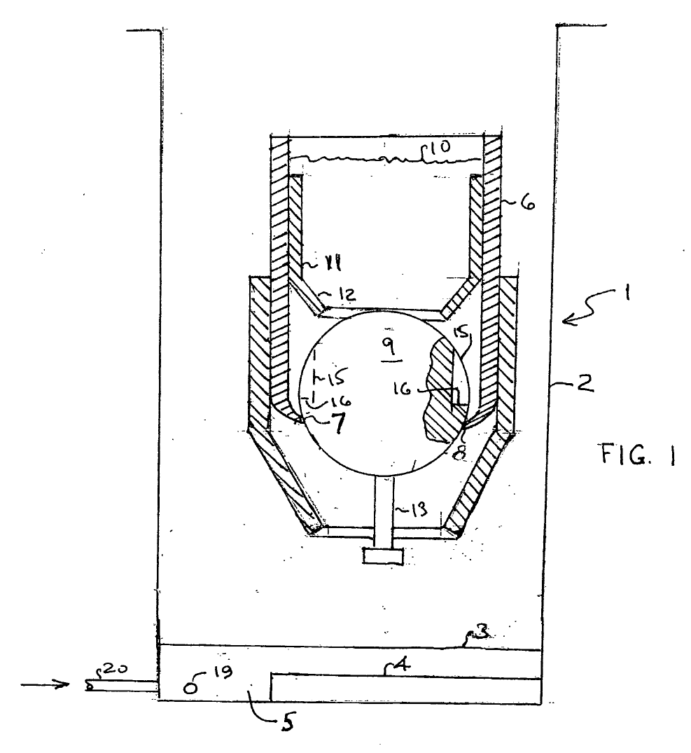

### DESCRIPTION OF THE PREFERRED EMBODIMENT

Pit 1, having side walls 2 and floor 3, is provided with feed trough 4 in the form of a recess in floor 3, and with water trough 5 in the form of a recess in floor 3.

Feed dispenser 6 is mounted within pit 1, as for example to a side wall 2, and has a feed discharge opening 7, as hereinafter described, overlying the feed trough 4.

As shown in the drawings, the lower extremity of feed dispenser 6 has portions 8 which converge around the lower portion of ball check 9, the said portions 8 defining the feed discharge opening 7.

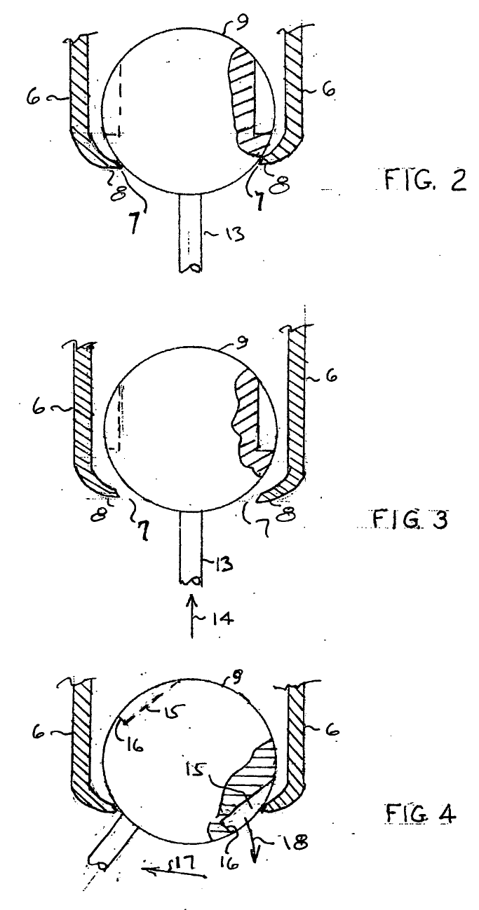

Ball check 9 rests on the converging portions 8 which, as particularly shown in FIG. 2, provide a seat for ball check 9, thus sealing feed discharge opening 7 and preventing feed 10 in feed dispenser 6 from exiting through feed discharge opening 7.

Upward movement of ball check 9 is limited by ball check adjustment drum 11 adjustably mounted within feed dispenser 6. Ball check adjustment drum 11 has at its bottom extremity an inwardly converging portion 12 adapted to engage the upper surface of ball check 9 at a predetermined elevation.

Means, not shown but well-known to those of ordinary skill in the mechanical arts, are provided to hold ball check adjustment drum 11 at the selected elevation in feed dispenser 6. In this manner, the volumetric rate of discharge of feed from feed dispenser 6 through feed discharge opening 7 is fixed at a preselected figure.

In other words, the vertical travel of ball check 9 and hence the area of feed discharge opening 7 between portions 8 and ball check 9 will be determined by the elevation of ball check 9 within feed dispenser 6, subject to the limitation imposed by the position of ball check adjustment drum 11 within feed dispenser 6.

The mature sow is easily trained to nudge feed lever 13, and hence ball check 9, upwardly when hungry, as shown diagrammatically by arrow 14 in FIG. 3, thereby to unseat ball check 9 over portions 8 and opening feed discharge opening 7 to the extent determined by ball check adjustment drum 11, so as to discharge feed 10 from feed dispenser 6 into underlying feed trough 4. The vertical position of ball check adjustment drum 11 can be adjusted, as aforesaid, to accommodate the requirements of particular sows, thereby to set the maximum opening of feed discharge opening 7. When the mature sow releases feed lever 13, ball check 9 because of its weight will drop down to the seat formed by portions 8, resealing feed discharge opening 7 over any bits of feed that may remain on portions 8.

However, as previously noted, piglets do not ordinarily have the strength to raise ball check 9 from its seated position on portions 8 of feed dispenser 6. In such case, feed discharge opening 7 would remain sealed and no feed could flow from feed dispenser 6 into the feed trough 4.

To correct this situation, crevices 15 are provided in ball check 9, as shown in the drawings, preferably in equispaced relation around that portion of the perimeter of ball check 9 that lies above portions 8 of feed dispenser 6. More particularly, with feed lever 13 in a vertical position, the bottoms of crevices 15 lie above feed discharge opening 7.

Two of such crevices 15 are shown in the drawings, and it will be noted that the lowermost portions thereof are flat as at 16. If three crevices are employed, they will be spaced 120° apart; four crevices 15 will be spaced 90° apart, and so on.

The piglet can nudge feed lever 13 laterally, as indicated by arrow 17 in FIG. 4, thus rotating ball check 9 on portions 8 and positioning a portion of a crevice 15 below portions 8 of feed dispenser 6. Feed in said crevice 15 will then drop into pit 1, as indicated by arrow 18.

It will be apparent that feed lever 13 can be pushed back laterally to its original vertical position or to any other position by the piglet.

Water button 19 is part of a water valve serviced by fresh water line 20. The sow and piglet are easily trained to nudge against water button 19 when thirsty, thereby to discharge water from fresh water line 20 into water trough 5.

Because modifications and changes which do not depart from the spirit of the invention as disclosed herein may occur to those skilled in the art to which this invention pertains, the appended claims should be construed as covering such modifications and equivalents as are suitable to the practice of the invention.

We claim:

1. Apparatus for dispensing feed on demand to swine and piglets, said apparatus comprising:
(a) a feed dispenser adapted to contain feed for swine and piglets and having an opening at the bottom thereof through which feed may be discharged from the feed dispenser.
(b) a seat on said feed dispenser around the periphery of said opening at the bottom of said feed dispenser, said seat functioning as a valve seat,
(c) a vertically movable and rotatable ball check in said feed dispenser and adapted to rest on said seat thereby to seal said opening and prevent the discharge of feed from said feed dispenser,
(d) a feed lever secured to the bottom of said ball check and adapted to be nudged upwardly by swine thereby to elevate said ball check above said seat to unseal said opening and permit the discharge of feed from said feed dispenser through said opening,
(e) a crevice formed in said ball check, said crevice lying entirely above said opening when said feed lever is in vertical position and adapted to be filled with feed from said feed dispenser,
(f) said feed lever being further adapted to be nudged laterally by a piglet so as to rotate said ball check on said seat thereby to bring the bottom portion of said crevice below said seat whereby to permit the discharge of feed from said crevice through said opening.

2. Apparatus as in claim 1, wherein:
(g) the bottom portion of said crevice is flat.

3. Apparatus as in claim 1, wherein:
(g) said apparatus comprises a plurality of crevices equispaced about the periphery of said ball check.

4. Apparatus as in claim 3, wherein:
(h) the bottom of each of said crevices is flat.

5. Apparatus as in claim 1, further comprising:
(g) a height-adjustable drum mounted to the inner wall of said feed dispenser and adapted to engage the upper surface of said ball check and limit the upward movement thereof.
